(19) United States
(12) Patent Application Publication
(10) Pub. No.: US 2020/0383340 A1
(43) Pub. Date: Dec. 10, 2020

(54) GRILL SMOKER BOX WITH PARTITIONED VOLUME FOR FOOD

(71) Applicant: SHELLY'S GRILLS, LLC, Sheboygan Falls, WI (US)

(72) Inventor: Scott Charles Larson, Sheboygan, WI (US)

(21) Appl. No.: 16/890,324

(22) Filed: Jun. 2, 2020

Related U.S. Application Data
(60) Provisional application No. 62/858,414, filed on Jun. 7, 2019.

(51) Int. Cl. A23B 4/052

(52) U.S. Cl. CPC A23B 4/0523

(57) ABSTRACT

A smoker box including a box assembly having a first compartment for receiving a food product, a second compartment for receiving a smoking agent, and a divider separating the compartments from one another. To produce the desired flow of heat and smoke, a bottom wall of the second compartment, the divider, and a side wall of the first compartment all have one or more air flow passageways. These passageways permit air to enter the second chamber to smoke the smoking agent and circulates the smoke over the food product in the first compartment by forcing the generated smoke into the first compartment. In some forms, there may be a removable rack configured to be placed within the first compartment that is designed to support a food product such as sausages.

### CROSS-REFERENCE TO RELATED APPLICATION

This application claims the benefit of U.S. Provisional Application No. 62/858,414 entitled “Grill Smoker Box With Partitioned Volume for Food” filed on Jun. 7, 2019, which is incorporated by reference herein for all purposes.

### FIELD OF INVENTION

This disclosure relates to a grilling accessory and more particularly to a box configured to smoke food, such as meat or vegetables, on an outdoor grill.

### BACKGROUND

Smoking meat or other foods is becoming an increasingly popular activity with the advent of at-home smoking equipment. The taste profile of a smoked food can be more complex and delicious than food that is only grilled.

At-home smoking equipment, however, can be expensive and require appreciable amounts of storage space. As such, a full size smoker may not be a reasonable purchase for people who may only occasionally want to smoke only a small quantity of food.

Accordingly, some smaller smoker boxes have been developed for in-grill placement. Typically, such boxes are relatively simplistic in design and receive the consumable wood chips. When the grill is started, the chips are also heated and consumed to fill the entire volume of the closed grill with smoke.

### SUMMARY

Many conventional smoker boxes which are sold as accessories are limited in their efficacy. While they do produce smoke, due to the circulation of air through the grill, the grill may not retain adequate concentrations of smoke inside the grilling chamber in order to flavor the food product robustly. Moreover, the smoke that is produced largely escapes when the grill cover is lifted. Further yet, to help improve flow of smoke over the food, some grills have been designed with smoker boxes that nest at the level of the grate or in which the food is received on top of the smoker. However, such configurations can complicate the construction of the grill, distance the food from the heat source, and/or fill additional vertical space within the grill cavity including space that would otherwise be available to receive food.

An improved grilling accessory or smoker box for placement onto a grill grate of an outdoor grill is disclosed herein in which the food may be placed inside the smoker box. The smoker box includes a partitioned volume including two separate, but connected, compartments: a chip-containing compartment and a food-containing compartment. Heat from the grill generates smoke from the chips in the chip-containing compartment and the generated smoke flows through openings in the partition wall into food-containing compartment to robustly smoke the food as the heat from the heating elements of the grill also cooks the food. The smoker box can have at least one removable rack on which the food can be placed during the cooking/smoking process and the at least one removable rack can be configured to be stackable with another removable rack of the same or similar configuration.

According to one aspect, a smoker box includes a box assembly with a first compartment and a second compartment separated by a divider and further includes a removable rack configured to be placed within the first compartment. Multiple passageways or openings in the walls of the box assembly may be used to manipulate flow of gases and smoke through the box assembly. The divider has one or more passageways extending therethrough, the first compartment has a side (in many instances, the side opposite the divider) with one or more passageways extending therethrough, and the second compartment has a bottom portion with one or more passageways extending therethrough.

According to another aspect, a smoker box includes a box assembly with a first side, a second side, a third side, a fourth side, a bottom side, and a divider. The divider is coupled to the first side, the second side, and the bottom side. A first compartment is defined by the third side, the divider, and portions of the first side, the second side, and the bottom side. A second compartment is defined by the fourth side, the divider, and portions of the first side, the second side, and the bottom side. The divider has one or more passageways extending therethrough, the portion of the bottom side defining a side of the second compartment has one or more passageways extending therethrough, and the third side has a plurality of passageways extending therethrough.

These and still other advantages of the invention will be apparent from the detailed description and drawings. What follows is merely a description of some preferred embodiments of the present invention. To assess the full scope of the invention the claims should be looked to as these preferred embodiments are not intended to be the only embodiments within the scope of the claims.

### BRIEF DESCRIPTION OF THE DRAWINGS

FIG. 1 is a partially exploded perspective view of an embodiment of a smoker box.

FIG. 2 is a top plan view of a box assembly of the smoker box of FIG. 1.

FIG. 3 is a perspective view of an embodiment of a removable rack of the smoker box of FIG. 1 with an example food provided thereon.

FIG. 4 is a front elevation view of the removable rack of FIG. 3.

FIG. 5 is a partially exploded perspective view of another embodiment of a smoker box similar to the embodiment of FIGS. 1-4, except that the box is taller and has a stacked pair of removable racks for food.

FIG. 6 is a top plan view of a box assembly of the smoker box of FIG. 5.

FIG. 7 is a front elevation view of an embodiment of a set of stacked removable racks of the smoker box of FIG. 5 with an example food provided thereon.

### DETAILED DESCRIPTION

Before any embodiments of the invention are explained in detail, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Some of the discussion below describes a grilling accessory that can be used with an existing outdoor grill to smoke food on the outdoor grill. The context and particulars of this discussion are presented as examples only. For example, while sausages are illustrated as the food product being smoked, embodiments of the disclosed grilling accessory can be used to smoke different types of proteins and meats, including ribs, other types of cased meats, hamburgers, and various other cuts of meat, and could be used to smoke other non-meat foods such as vegetables.

Some of the discussion below also describes the configuration of the smoker box. The context and particulars of this discussion are presented as examples only. For example, embodiments of the disclosed invention can be constructed from a variety of differently-shaped components that are assembled in various configurations, only some of which will be described herein.

As noted above, food smoking devices are often stand-alone equipment that are separate from grills and therefore add appreciable cost and space requirements. Further, such conventional smoking devices are designed with large batches of food in mind. To permit a conventional grill owner to smoke, smoker boxes have been designed for use with conventional grills that provides a chip or smoking-agent receiving chamber that produces smoke when the grill is heated. However, available smoker boxes often do not produce enough smoke for the volume of the grill based on air flow rates through the grill and/or include vertical designs that separate the food product from the heat source of the grill and that require additional vertical space on the grill (which vertical space may not be available or permit the grill to be full closed on all makes and models of grills).

The disclosed smoker box addresses these and other issues. For example, in some embodiments, a smoker box can be arranged directly on the grate of a standard outdoor grill, not require an additional cooking implement, and can be used to smoke a smaller quantity of food robustly in an easy to operate device.

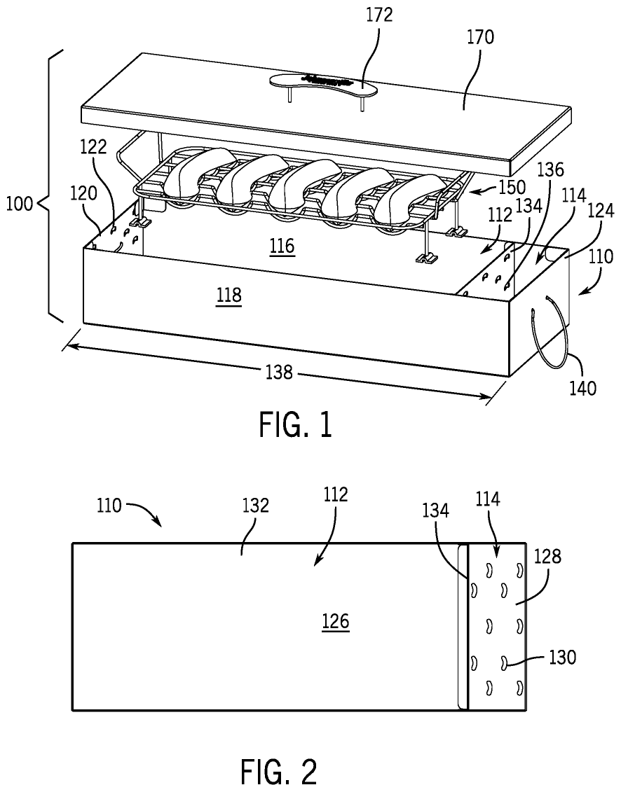

FIG. 1 illustrates a smoker box 100 in a partially exploded view. The smoker box 100 has a box assembly 110, a rack 150, and a cover 170. With additional reference being made to FIG. 2, the box assembly 110 can be substantially rectangular as shown with a length 138 and has a first side 116, a second side 118, a third side 120, a fourth side 124, a bottom side 126, a divider 134, (all planar walls, in the form illustrated) and a set of handles 140 provided in the third and fourth sides 120, 124.

The divider 134 is coupled to the first side 116, the second side 118, and the bottom side 126 and further defines a first compartment 112 and a second compartment 114 within the box assembly 110 by bifurcation of the inner chamber of the box assembly 110. Accordingly, the first compartment 112 and the second compartment 114 are arranged in a side-by-side manner according to this embodiment with the divider 134 separating them. The divider 134 is shown with a plurality of passageways 136 extending therethrough to permit gaseous communication between the first compartment 112 and second compartment 114.

The first compartment 112 is sized to receive the rack 150 therein. As illustrated, the first compartment 112 is defined by the third side 120, the divider 134, and portions of the first side 116, the second side 118, and the bottom side 126. The third side 120 has a plurality of passageways 122 extending therethrough to place the first compartment 112 in gaseous communication with the external environment (for example, the inside chamber of the grill).

The second compartment 114 is configured to receive a smoking agent therein, such as wood chips. The second compartment is defined by the fourth side 124, the divider 134, and portions of the first side 116, the second side 118, and the bottom side 126. The bottom portion 128 of the bottom side 126 defining a side in the second compartment 114 also has a plurality of passageways 130 extending therethrough to permit transfer of heat and/or flame from the grill into the second compartment 114.

As best shown in FIG. 1, a cover 170 is sized and configured to cover both the first compartment 112 and the second compartment 114 of the box assembly 110. The cover 170 has a cover handle 172 for ease of placement and removal of the cover 170 onto and from the box assembly 110.

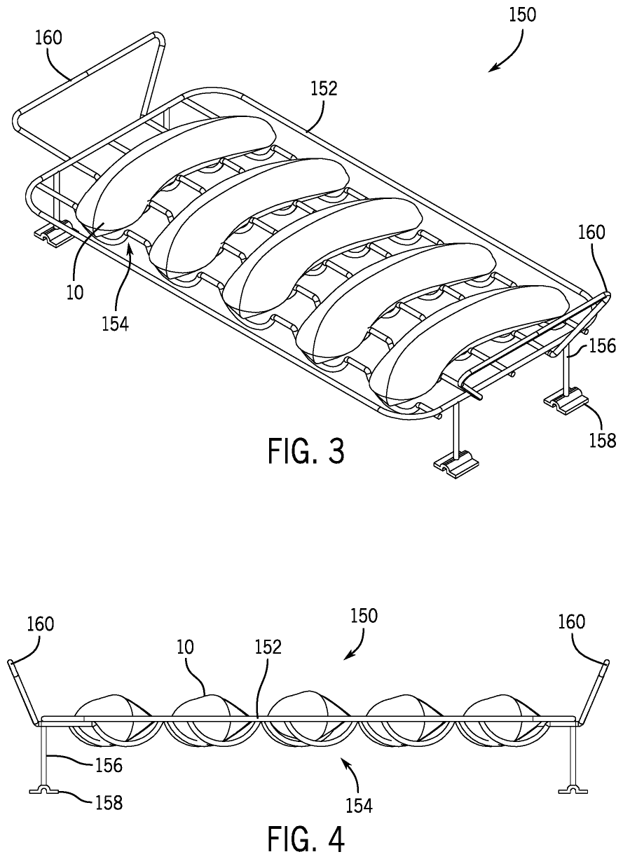

FIGS. 3 and 4 illustrate the rack 150 in greater detail. The rack 150 has a food placement area 152, feet 156 extending downward from the food placement area 152, and grips 160 or handles extending from the food placement area 152 in a direction substantially opposite of the feet 156 (for example and as illustrated, upward and outward). The feet 156 further have saddle-shaped portions 158 at the distal ends thereof that may be used to accommodate stacking of such racks in some configurations.

The rack 150 is removable from the box assembly 110 and is configured to position food placed on the food placement area 152 above a bottom surface 132 in the first compartment 112. Here, the food shown is a cased protein product 10 such as a sausage, but other types of foods are contemplated, such as other protein or vegetable based products and vegetables. The removability of the rack 150 can provide easier cleanup of both the rack 150 and the box assembly 110 and can permit the rack 150 to be used as a serving device in a table setting.

In the form illustrated, the removable rack 150 can further comprise at least one food-shaped section 154 in the food placement area 152 that is configured to receive at least a portion of the food to be smoked thereon. As shown in FIGS. 3 and 4, the food-shaped sections 154 are shaped to resemble the curved dimensions of the cased protein product 10. The food-shaped sections 154 provide even spacing of the food and, in the case of round foods, can reduce the likelihood of the food rolling off the rack 150 or sliding during handling of the rack 150. In this regard, the removability and replaceablity of the rack permits for the use of multiple different types of racks—some potentially unique to a food or being food-shape specific—to be used with a single smoker box.

In use, the smoker box 100 is placed on a grill grate of an outdoor grill, the rack 150 is put into the first compartment 112 of the box assembly 110, food is placed on the food placement area 152, a smoking agent is placed in the second compartment 114, and the cover 170 is placed over the box assembly 110. Heat produced by the outdoor grill (for example by consuming charcoal or from a flammable gas source) heats the smoking agent and the smoke generated from the smoking agent is drawn through the box assembly 110 from the second compartment 114 through the first compartment 112 as air is drawn through the plurality of passageways 128 in the bottom portion 128 of the bottom side 126 in the second compartment 114, through the plurality of passageways 136 in the divider 134, and out through the plurality of passageways 122 in the third side 120.

During cooking/smoking of the food, it is possible that parts of the food, such as grease, will drip through the food placement area 152 of the rack 150. The bottom surface 132 of the bottom side 126 in the first compartment 112 prevents those droppings from falling straight through to the outdoor grill and the divider 134 further inhibits those droppings from falling through the plurality of passageways 130 in the bottom portion 128 of the bottom side 126 in the second compartment 114. In this way, such food drippings such as grease are less likely to ignite and burn the food product given they are not exposed directly to a flame.

It should be appreciated that nearly all smoke generated from the smoking agent will be directed into the food-containing compartment. Moreover, as the food-containing compartment has a volume appreciably smaller than the entire volume of the overall grill when closed, the smoke is much more concentrated and effective at smoking the food product in comparison to smoker boxes that are designed to produce smoke for the entire volume of the closed grill. Additionally, unlike such “whole grill” smoker boxes, the smoke in the food-containing compartment is not continuously lost through the airflow of the grill (or at least not at the same rates and not without first forcing the smoke over the food) and is not entirely lost when the grill cover is opened.

Still further, by the side-by-side placement of the compartments, the food-containing compartment remains relatively close to the heat source (for example, the flame or ignited charcoal) as opposed to those smoker box designs in which food is placed above the smoker box to increase smoke exposure. The side-by-side configuration also permits low-profile smoker boxes which can be received in nearly all styles of grills without concern of interference with a top rack.

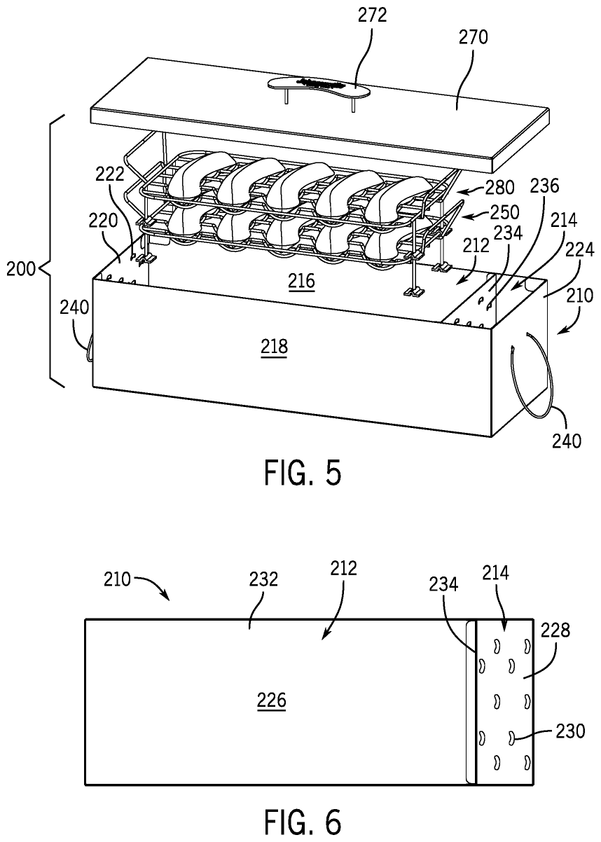

Turning now to FIGS. 5 and 6, FIGS. 5 and 6 illustrate another embodiment of a smoker box 200. In many aspects, the smoker box 200 is similar to the smoker box 100 described above and similar numbering, in the 200 series, is used for the smoker box 200 to describe similar features (for example, divider 134 and divider 234 are generally similar in structure and function). The smoker box 200 has a box assembly 210 with a first side 216, a second side 218, a third side 220, a fourth side 224, a bottom side 226, a divider 234 dividing the box assembly 210 into a first compartment 212 and a second compartment 214, and a set of handles 240 provided at the third and fourth sides 220, 224. Similarly to the first embodiment, the third side 220, a bottom portion 228 of the bottom side 226 in the second compartment 214, and the divider 234 each have a plurality of passageways 222, 230, 236, extending therethrough, respectively to create the desired airflow through the box 200 during use. The smoker box 200 also includes a cover 270 with a cover handle 272.

While their overall construction is similar, in some aspects, the smoker boxes 100 and 200 differ from each other. For example, one way in which the smoker boxes 100 and 200 differ is that first side 216, the second side 218, the third side 220, and the fourth side 224 are taller to accommodate a first rack 250 and a second rack 280 in a stacked configuration. This permits the smoking and cooking of double the amount of food of a single rack design such as is found in the first embodiment.

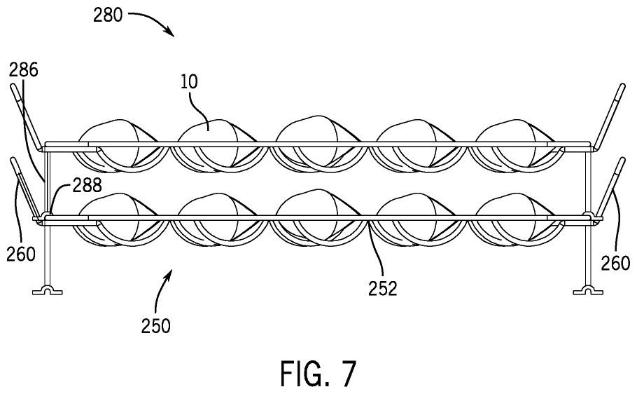

FIG. 7 illustrates the stacked configuration of the first and second racks 250 and 280, which are also shown in FIG. 5. The saddle-shaped portions 288 of the feet 286 of the second rack 280 are configured to receive a portion of the wire frame of the food placement area 252 of the first rack 250. The feet 286 of the second rack 280 are preferably received on the food placement area 252 of the first rack 250 adjacent to the locations where the grips 260 extend from the food placement area 252. This arrangement reduces the likelihood that the second rack 280 will translate or move relative to the first rack 250 when stacked.

The connection between the first rack 250 and the second rack 280 is primarily maintained through gravity and lifting of the second rack 280 relative to the first rack 250 will separate the two. Therefore, movement of the stacked combination of the first rack 250 and the second rack 280 can be achieved by lifting the combination by the grips 260 of the first food rack 250.

As noted above, it should be appreciated that various other modifications and variations to the preferred embodiments can be made within the spirit and scope of the invention. Therefore, the invention should not be limited to the described embodiments. To ascertain the full scope of the invention, the following claims should be referenced.

What is claimed is:

1. A smoker box comprising:
a box assembly having with a first compartment and a second compartment separated by a divider;
a removable rack configured to be placed within the first compartment;
wherein the divider has a plurality of passageways extending therethrough;
wherein the first compartment has a side opposite the divider, the side of the first compartment having a plurality of passageways extending therethrough; and
wherein the second compartment has a bottom portion with a plurality of passageways extending therethrough.

2. The smoker box of claim 1, wherein the second compartment is configured to house a smoking agent.

3. The smoker box of claim 1, wherein the first compartment and the second compartment are positioned side-by-side along a length of the box assembly.

4. The smoker box of claim 1, wherein the removable rack has a food placement area and feet extending therefrom, the removable rack is configured to position food placed on the food placement area above a bottom surface in the first compartment.

5. The smoker box of claim 4, wherein the food placement area has one or more food-shaped sections shaped to correspond to and to receive at least a portion of the food to be smoked thereon.

6. The smoker box of claim 4, wherein the removable rack is configured to be stackable with a second removable rack.

7. The smoker box of claim 6, wherein the feet of the removable rack are configured to removably engage a portion of the second removable rack.

8. The smoker box of claim 4, wherein the removable rack has a set of grips extending from the food placement area substantially in the direction opposite the feet.

9. The smoker box of claim 1, wherein the smoker box further comprises a cover configured to cover both the first compartment and the second compartment.

10. The smoker box of claim 1, wherein the smoker box further comprises a set of handles.

11. A smoker box comprising:
a box assembly having a first side, a second side, a third side, a fourth side, a bottom side, and a divider in which the divider is coupled to the first side, the second side, and the bottom side;
wherein a first compartment is defined by the third side, the divider, and portions of the first side, the second side, and the bottom side;
wherein a second compartment is defined by the fourth side, the divider, and portions of the first side, the second side, and the bottom side;
wherein the divider, the portion of the bottom side defining a side of the second compartment, and the third side each have a respective plurality of passageways extending therethrough.

12. The smoker box of claim 11, wherein the second compartment is configured to house a smoking agent.

13. The smoker box of claim 11, wherein the first compartment and the second compartment are positioned side-by-side along a length of the box assembly.

14. The smoker box of claim 11, further comprising a removable rack with a food placement area and feet extending therefrom, the removable rack being configured to position food placed on the food placement area above a bottom surface of the bottom side in the first compartment.

15. The smoker box of claim 14, wherein the food placement area has one or more food-shaped sections shaped to correspond to and to receive at least a portion of the food to be smoked thereon.

16. The smoker box of claim 14, wherein the removable rack is configured to be stackable with a second removable rack.

17. The smoker box of claim 16, wherein the feet of the removable rack are configured to removably engage a portion of the second removable rack.

18. The smoker box of claim 14, wherein the removable rack has a set of grips extending from the food placement area substantially in the direction opposite the feet.

19. The smoker box of claim 11, wherein the smoker box further comprises a cover configured to cover both the first compartment and the second compartment.

20. The smoker box of claim 11, wherein the smoker box further comprises a set of handles.
